(19) United States
(12) Patent Application Publication
(10) Pub. No.: US 2014/0303982 A1
(43) Pub. Date: Oct. 9, 2014

(54) PHONETIC CONVERSATION METHOD AND DEVICE USING WIRED AND WIRESS COMMUNICATION

(71) Applicant: Yally Inc., Ansan-si (KR)

(72) Inventor: JAE MIN YUN, Ansan-si (KR)

(73) Assignee: Yally Inc., Ansan-si (KR)

(21) Appl. No.: 14/150,955

(22) Filed: Jan. 9, 2014

(30) Foreign Application Priority Data
Apr. 9, 2013 (KR) 10-2013-0038746
Jan. 2, 2014 (KR) 10-2014-0000063

(51) Int. Cl. G10L 25/48

(52) U.S. Cl. CPC G10L 25/48
USPC 704/270

(57) ABSTRACT

A phonetic conversation method using wired and wireless communication networks includes: receiving, by a voice input unit of a phonetic conversation device, a voice that is input by a user; receiving, by a wired and wireless communication unit of the phonetic conversation device, a voice that is input through the voice input unit and transmitting the voice to a mobile terminal; receiving, by the wired and wireless communication unit, an answer voice that is transmitted from the mobile terminal; and receiving and outputting, by a voice output unit of the phonetic conversation device, a voice from the wired and wireless communication unit.

### CROSS-REFERENCE TO RELATED APPLICATION

This application claims priority to and the benefit of Korean Patent Application Nos. 10-2013-0038746 and 10-2014-0000063 in the Korean Intellectual Property Office on Apr. 9, 2013 and Jan. 2, 2014, the entire contents of which are incorporated herein by reference.

### BACKGROUND OF THE INVENTION

(a) Field of the Invention

A phonetic conversation method and device using wired and wireless communication networks is provided.

(b) Description of the Related Art

A question and answer system generally asks a question to a system so as to obtain knowledge that a user wants, analyzes the user's question, and outputs an answer to the question. Up to now, a question and answer system has been embodied by various methods. However, it is inconvenient to use a question and answer system in which a question and an answer are stored and expressed in a text form.

Korean Patent Laid-Open Publication No. 2009-0034203 discloses an attachable and removable switch apparatus.

The above information disclosed in this Background section is only for enhancement of understanding of the background of the invention and therefore it may contain information that does not form the prior art that is already known in this country to a person of ordinary skill in the art.

### SUMMARY OF THE INVENTION

An embodiment of the present invention provides a phonetic conversation method using wired and wireless communication networks, the phonetic conversation method including: receiving, by a voice input unit of a phonetic conversation device, a voice that is input by a user in a case of a touch, an eye contact, or a user voice input; receiving, by a wired and wireless communication unit of the phonetic conversation device, a voice that is input through the voice input unit and transmitting the voice to a mobile terminal; receiving, by the wired and wireless communication unit, an answer voice that is transmitted from the mobile terminal; and receiving and outputting, by a voice output unit of the phonetic conversation device, a voice from the wired and wireless communication unit.

In an embodiment, the receiving of a voice that is input by a user may include: recognizing, by a touch recognition unit or an image output unit of the phonetic conversation device, a user touch; receiving, by the voice input unit of the phonetic conversation device, a voice that is input by the user, after a user touch is recognized in the touch recognition unit or the image output unit or while a user touch is maintained; and receiving, by the voice input unit of the phonetic conversation device, a voice that is input by the user, after a voice is input without a user touch to the touch recognition unit or the image output unit, when the voice is determined to a user voice.

In an embodiment, the receiving of a voice that is input by a user may include: recognizing, by an image input unit of the phonetic conversation device, an eye contact of a user; receiving, by the voice input unit of the phonetic conversation device, a voice that is input by the user, after the eye contact of the user is recognized through the image output unit or while the eye contact of the user is maintained; and receiving, by the voice input unit of the phonetic conversation device, a voice that is input by the user, after a voice is input without the eye contact of the user through the image output unit, when the voice is determined to a user voice.

In an embodiment, the receiving and outputting of a voice may include emitting and displaying, by a light emitting unit of the phonetic conversation device, light with a specific color based on an emotion that is determined for the voice while receiving and outputting a voice from the wired and wireless communication unit.

In an embodiment, a light emitting color and a display cycle of the light emitting unit may be determined based on an emotion that is determined for the voice in the mobile terminal.

In an embodiment, the emotion is recognized from a natural language text after converting the voice to a text.

In an embodiment, the receiving and outputting of a voice may include outputting, by a light emitting unit of the phonetic conversation device, a facial expression image based on an emotion that is determined for the voice while receiving and outputting a voice from the wired and wireless communication unit.

In an embodiment, the receiving and outputting of a voice may include outputting, by a light emitting unit of the phonetic conversation device, an emoticon based on an emotion that is determined for the voice while receiving and outputting a voice from the wired and wireless communication unit.

An embodiment of the present invention provides a phonetic conversation device using wired and wireless communication networks, the phonetic conversation device including: a voice input unit configured to receive a voice that is input by a user in a case of a touch, an eye contact, or a user voice input; a wired and wireless communication unit configured to receive a voice that is input through the voice input unit, to transmit the voice to a mobile terminal, and to receive the voice that is transmitted from the mobile terminal; and a voice output unit configured to receive the voice from the wired and wireless communication unit and to output the voice.

In an embodiment, the phonetic conversation device may further include a touch recognition unit configured to recognize a user touch, wherein after a user touch is recognized in the touch recognition unit or while a user touch is maintained, a voice is input by the user.

In an embodiment, the phonetic conversation device may further include an image input unit configured to receive an input of a user image, wherein after the eye contact of the user is recognized in the image input unit or while the eye contact is maintained, a voice is input by the user.

In an embodiment, the phonetic conversation device may further include a light emitting unit configured to emit and displays light with a specific color based on an emotion that is determined for the voice while the voice output unit receives a voice from the wired and wireless communication unit and outputs the voice.

In an embodiment, the phonetic conversation device may further include an image output unit that outputs an image.

In an embodiment, while the voice output unit receives a voice from the wired and wireless communication unit and outputs the voice, the image output unit may output a facial expression image based on an emotion that is determined for the voice.

In an embodiment, while the voice output unit receives a voice from the wired and wireless communication unit and outputs the voice, the image output unit may output an emoticon based on an emotion that is determined for the voice.

### BRIEF DESCRIPTION OF THE DRAWINGS

FIG. 1 is a diagram illustrating a configuration of a phonetic conversation system according to an exemplary embodiment of the present invention.

FIG. 2 is a message transmitting and receiving flowchart between a phonetic conversation device and a mobile terminal in a phonetic conversation system according to an exemplary embodiment of the present invention.

FIG. 3 is a message transmitting and receiving flowchart between a phonetic conversation device and a mobile terminal in a phonetic conversation system according to an exemplary embodiment of the present invention.

FIG. 4 is a diagram illustrating an example of transferring emotion information to an App by a touch.

FIG. 5 is a diagram illustrating an example of a volume control of a phonetic conversation device according to an exemplary embodiment of the present invention.

FIG. 6 is a diagram illustrating an example of conversation with a conversation toy (doll) by a user voice input.

FIG. 7 is a diagram illustrating an example of generating phonetic conversation and having conversation in a mobile terminal App.

FIG. 8 is a diagram illustrating an example of turning on a phonetic conversation device according to an exemplary embodiment of the present invention.

FIG. 9 is a diagram illustrating an example of a pairing function according to an exemplary embodiment of the present invention.

FIG. 10 is a diagram illustrating an example of battery discharge warning of a phonetic conversation device according to an exemplary embodiment of the present invention.

FIGS. 11 to 21 are diagrams illustrating an example of a kind of facial expressions of a conversation toy (doll).

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification. Further, a detailed description of well-known technology will be omitted.

In addition, in the entire specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

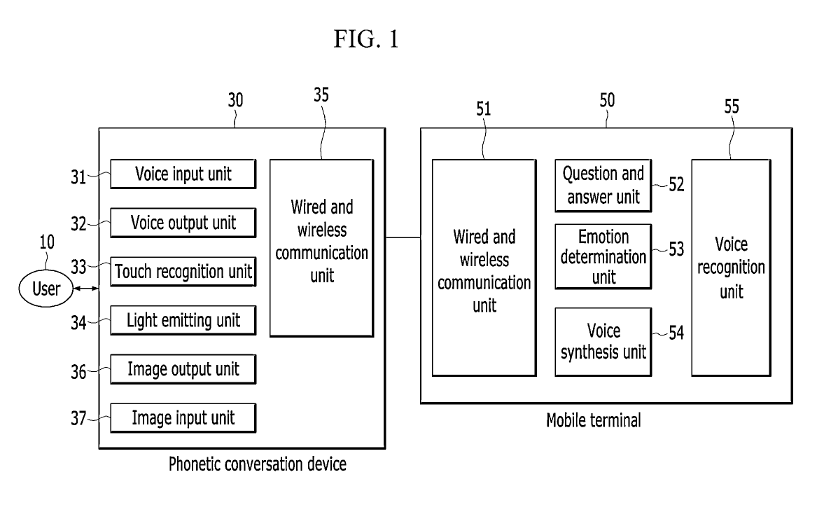

FIG. 1 is a diagram illustrating a configuration of a phonetic conversation system according to an exemplary embodiment of the present invention.

Referring to FIG. 1, the phonetic conversation system may include a user 10, a phonetic conversation device 30, and a mobile terminal 50.

The phonetic conversation device 30 is housed within a toy (doll) for voice recognition question and answer with the user 10, is formed in an attachable and removable form, or is fixed by a belt to be used in a form that may be fixed to the toy (doll). The phonetic conversation device 30 includes a voice input unit 31, a voice output unit 32, a touch recognition unit 33, a light emitting unit 34, and a wired and wireless communication unit 35. The phonetic conversation device 30 may further include an image output unit 36 and an image input unit 37.

In order to input a voice, when the user 10 touches the touch recognition unit 33, the touch recognition unit 33 is operated. When the touch recognition unit 33 is operated, the user 10 may input a voice.

When the user 10 inputs a voice by touching the touch recognition unit 33, a special user interface for receiving a voice input like a Google vocal recognition device is used. When a voice is input on a source code without a special user interface like a nuance vocal recognition device, a voice may be input without operation of the touch recognition unit.

As the touch recognition unit 33 operates, when the user 10 is in a state that they may input a voice, the voice input unit 31 receives an input of a voice that is input by the user 10 and transfers the voice to the wired and wireless communication unit 35.

Further, even if the touch recognition unit 33 is not operated, the voice input unit 31 may use a self voice detection engine or algorithm, and in this case, when the input sound is determined as a person's voice, the voice input unit 31 may receive an input of a voice and transfer the voice to the wired and wireless communication unit 35.

In order to input a voice, when the user 10 quickly touches one time or continues to touch for about 1 to 2 seconds and inputs a voice, voice input completion may be automatically detected by a voice detection algorithm, and a separately formed vocal recognition device may determine whether a voice input is complete and notify the voice input unit 31 of voice input completion.

Further, a rule of quickly touching the voice input unit 31 one time or continuing to touch for about 1 to 2 seconds and inputting a voice for a predetermined time, for example, several seconds, may be previously set. In this case, a voice that is input within a predetermined time may be transferred to the vocal recognition device.

The voice input unit 31 may receive a voice input only while the user 10 touches. In this case, when the touch of the user 10 is detached, a voice that is stored at a temporary memory may be transferred to the wired and wireless communication unit 35.

When the wired and wireless communication unit 35 receives a voice that is input from the voice input unit 31, the wired and wireless communication unit 35 compresses a corresponding voice using a codec, and transmits the compressed voice to the mobile terminal 50 by wired communication or wireless communication.

The wired and wireless communication unit 35 receives and decodes the compressed voice that is transmitted from the wired and wireless communication unit 51 of the mobile terminal 50, and transfers the decoded voice to the voice output unit 32.

The voice output unit 32 outputs the decoded voice and thus the user can hear the output voice. For example, the voice output unit 32 may include a speaker.

When transmission capacity of data is small and transmission speed of data is fast, the wired and wireless communication unit 35 may transmit a voice that is input from the voice input unit 31 to the mobile terminal 50 by wired communication or wireless communication without compression, and a voice that is transmitted from the wired and wireless communication unit 51 of the mobile terminal 50 may be transferred to the voice output unit 32 without decoding.

When a touch of the user 10 is recognized by the touch recognition unit 33 and a touch recognition signal is transferred to the light emitting unit 34, the light emitting unit 34 may display light of a predetermined kind with a predetermined cycle. Further, when a voice that is transmitted from the mobile terminal 50 is output through the voice output unit 32, the light emitting unit 34 may display light of a predetermined kind with a predetermined cycle. Information about a light emitting condition such as a kind of light and a display cycle of light may be determined by an emotion determination unit 53 of the mobile terminal 50, and information about the determined light emitting condition may be transmitted to the phonetic conversation device 30. For example, the light emitting unit 34 may include a light emitting diode (LED).

The image output unit 36 outputs an image, and may include a touch screen. The output image may include a touch button. The touch button may be a button that notifies the start of voice recognition, a button that adjusts a volume, and a button that turns a power supply on/off. For example, a time point at which the user 10 touches an output image may be a start point of voice recognition. Completion of a voice input may be automatically detected by a voice detection algorithm of the voice input unit 31, and may be recognized by a separately formed vocal recognition device. The recognized voice is transmitted to the mobile terminal 50 through the wired and wireless communication unit 35. The image output unit 36 may include a display such as a liquid crystal display (LCD) and an organic light emitting diode (OLED).

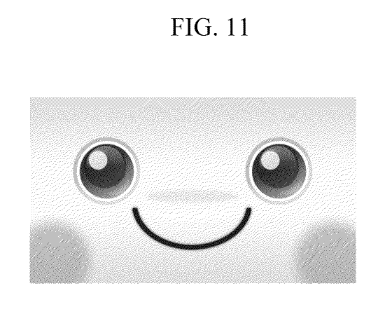

Further, as shown in FIGS. 11 to 21, the image output unit 36 may output various facial expressions according to an emotion that is extracted from an answer to a question of the user 10. The facial expression may include an emoticon. A facial expression of the image output unit 36 and a voice output of the voice output unit 32 may be simultaneously output like actual talk. Accordingly, when the user 10 views a change of a facial expression of a toy (doll) to which the phonetic conversation device 30 is fixed and hears a voice, the user 10 may perceive a real feeling.

The image input unit 37 receives input of an image, and may include a camera and an image sensor. The image that is input through the image input unit 37 is transmitted to the mobile terminal 50 through the wired and wireless communication unit 35. The mobile terminal 50 determines whether a pupil of the user 10 faces the image input unit 37. For example, a time point at which a pupil of the user 10 faces the image input unit 37 may be a start point of voice recognition. Completion of a voice input may be automatically detected by a voice detection algorithm of the voice input unit 31 and may be recognized by a separately formed vocal recognition device, and the recognized voice is transmitted to the mobile terminal 50 through the wired and wireless communication unit 35. When a voice is input to the voice input unit 31 without a user's eye contact, it is determined whether the input voice is a voice of the user 10, and when the input voice is a voice of the user 10, the voice may be input.

The image input unit 37 may receive a voice input only while eye contact of the user 10 is made, and in this case, when the user 10 no longer makes eye contact, a voice that is stored at a temporary memory may be transferred to the wired and wireless communication unit 35.

The mobile terminal 50 is a terminal for communicating by wire or wireless with the phonetic conversation device 30, and generates an answer to a question that is transmitted by wire or wireless from the phonetic conversation device 30 into voice synthesis data or represents various facial expressions.

For example, the mobile terminal 50 includes a personal computer (PC), a personal digital assistant (PDA), a laptop computer, a tablet computer, a mobile phone (iPhone, Android phone, Google phone, etc.), and a medium in which interactive voice and data communication is available, and various terminals including equipment in which wired and wireless Internet or wired and wireless phone (mobile) communication is available may be used.

When the mobile terminal 50 communicates by wire with the phonetic conversation device 30, in a state in which the mobile terminal 50 is installed in a face portion of a toy (doll), the mobile terminal 50 is connected to the phonetic conversation device 30 by wired communication to generate an answer to a user's question that is transmitted from the phonetic conversation device 30 into voice synthesis data and transmits the generated voice synthesis data to the phonetic conversation device 30. In this case, an expression of the toy (doll) may be various facial expressions according to an emotion that is extracted from an answer to the user's question by the mobile terminal 50 that is installed in a face portion of the toy (doll), as shown in FIGS. 11 to 21.

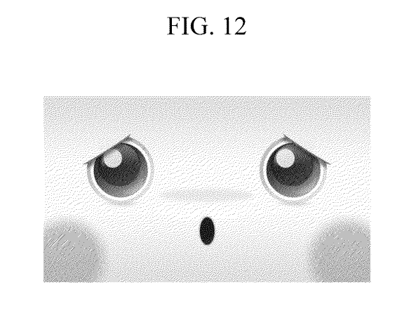

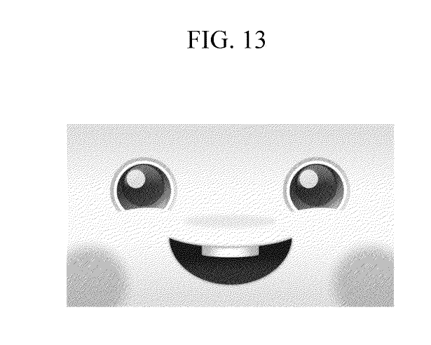

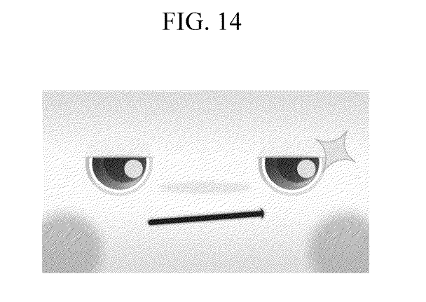

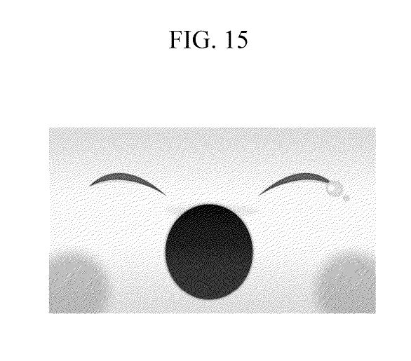

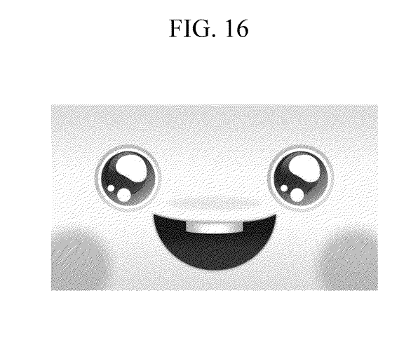

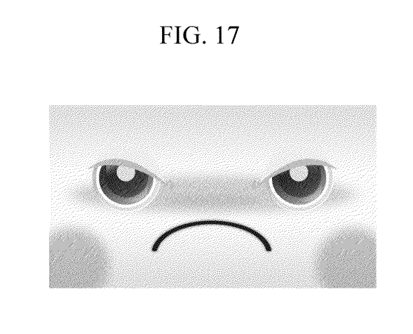

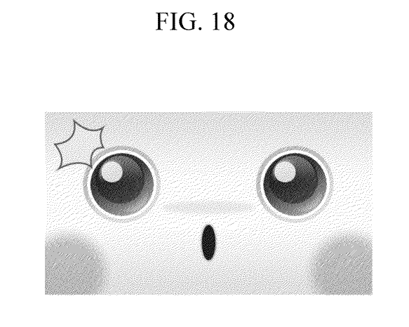

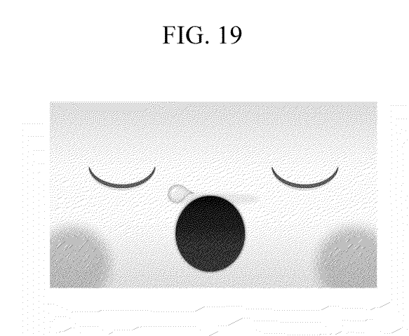

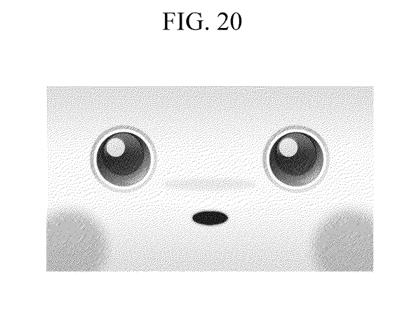

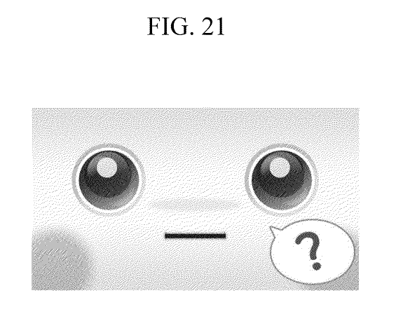

FIGS. 11 to 21 are diagrams illustrating an example of a kind of facial expressions of a conversation toy (doll), FIG. 11 represents a calm emotion, FIG. 12 represents worry and anxiety, FIG. 13 represents an emotion of delight, FIG. 14 represents an emotion of doubt, FIG. 15 represents an emotion of lassitude, FIG. 16 represents an emotion of expectation, FIG. 17 represents an emotion of anger, FIG. 18 represents an emotion of a touch action, FIG. 19 represents a sleeping action, FIG. 20 represents a speaking action, and FIG. 21 represents a hearing action.

When the mobile terminal 50 communicates by wireless with the phonetic conversation device 30, the mobile terminal 50 may not be installed in a face portion of a toy (doll), and may be located within a distance that may communicate by wireless with the phonetic conversation device 30. The mobile terminal 50 generates an answer to a user's question that is transmitted by wireless communication from the phonetic conversation device 30 into voice synthesis data, and transmits the generated voice synthesis data to the phonetic conversation device 30.

The mobile terminal 50 includes a wired and wireless communication unit 51, a question and answer unit 52, the emotion determination unit 53, a voice synthesis unit 54, and a voice recognition unit 55.

The wired and wireless communication unit 51 receives and decodes a compressed voice that is transmitted by wired communication or wireless communication from the wired and wireless communication unit 35 of the phonetic conversation device 30, changes the decoded voice to a format for voice recognition, and transmits the changed voice to the voice recognition unit 55.

The voice recognition unit 55 recognizes a voice that is received from the wired and wireless communication unit 51 and transfers a question text, which is a voice recognition result to the question and answer unit 52.

When the question and answer unit 52 receives a question text from the voice recognition unit 55, the question and answer unit 52 generates an answer text of the question text and transfers the answer text to the voice synthesis unit 54.

When the voice synthesis unit 54 receives the answer text from the question and answer unit 52, the voice synthesis unit 54 generates voice synthesis data by synthesizing the answer text to a voice and transfers the generated voice synthesis data to the wired and wireless communication unit 51.

The emotion determination unit 53 extracts an emotion of the answer text, determines information about a light emitting condition such as a kind of light and a display cycle of light for displaying specific light in the light emitting unit 34 of the phonetic conversation device 30 for the extracted emotion, and transfers the information to the wired and wireless communication unit 51. Further, the emotion determination unit 53 determines various facial expressions of the extracted emotion and transfers the determined facial expression to the wired and wireless communication unit 51, as shown in FIGS. 11 to 21. The emotion determination unit 53 may transmit transferred information about a light emitting condition and various facial expressions to the wired and wireless communication unit 51 to each of the light emitting unit 34 and the image output unit 36 through the wired and wireless communication unit 35 of the phonetic conversation device 30.

For example, in order to extract an emotion from the answer text, by analyzing the answer text with a natural language processing (morpheme analysis, phrase analysis, and meaning analysis) method, emotions that are included within the answer text may be classified.

When voice synthesis data is transferred from the voice synthesis unit 54, the wired and wireless communication unit 51 transmits compressed voice synthesis data by compressing voice synthesis data in which a voice is synthesized, information about a light emitting condition such as a kind of light and a display cycle of light that are determined by the emotion determination unit 53, and various facial expressions to the phonetic conversation device 30.

When a transmission capacity of data is small and a transmission speed of data is fast, the wired and wireless communication unit 51 receives a voice that is transmitted by wired communication or wireless communication from the wired and wireless communication unit 35 of the phonetic conversation device 30, and transfers the received voice to the voice recognition unit 55 without decoding. In this case, the voice recognition unit 55 recognizes a voice that is transferred from the wired and wireless communication unit 51 and transfers a question text, which is a voice recognition result, to the question and answer unit 52.

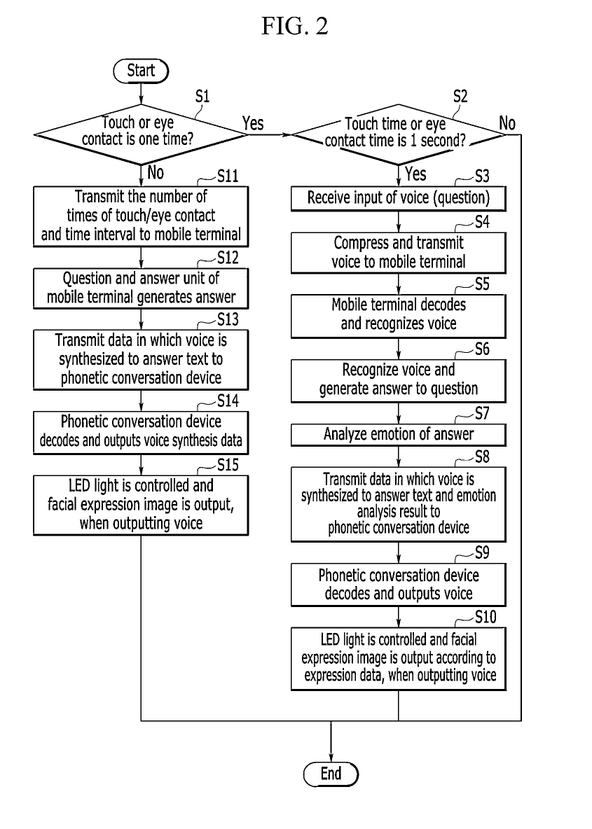

FIG. 2 is a message transmitting and receiving flowchart between a phonetic conversation device and a mobile terminal in a phonetic conversation system according to an exemplary embodiment of the present invention.

Referring to FIG. 2, the phonetic conversation device 30 determines whether the user 10 touches or makes eye contact with the image input unit 37 of the phonetic conversation device 30 one time (S1), and if the user 10 touches or makes eye contact one time, the phonetic conversation device 30 determines whether a touch time or an eye contact time is 1 second (S2).

If a touch time or an eye contact time is 1 second, the phonetic conversation device 30 receives an input of a voice (question) of the user 10 (S3), and the phonetic conversation device 30 compresses a voice and transmits the voice (question) to the mobile terminal 50 (S4).

The mobile terminal 50 decodes and recognizes a voice that is compressed in and transmitted from the phonetic conversation device 30 (S5), generates an answer to the question (S6), and analyzes an emotion of the answer (S7).

The mobile terminal 50 transmits voice synthesis data in which a voice is synthesized to an answer text and information about an emotion analysis result to the phonetic conversation device 30 (S8). For example, information about an emotion analysis result may be information about a light emitting condition such as a kind of light for displaying specific light in the light emitting unit 34 of the phonetic conversation device 30 and a display cycle of light and various facial expressions of an emotion that is extracted by the emotion determination unit 53, as shown in FIGS. 11 to 21.

The phonetic conversation device 30 decodes and outputs a voice that is transmitted from the mobile terminal 50 (S9), and when outputting a voice, the phonetic conversation device 30 controls LED light according to emotion data, which is an emotion analysis result that is transmitted from the mobile terminal 50, and outputs a facial expression image (S10).

If the user 10 does not touch or does not make eye contact with the image input unit 37 of the phonetic conversation device 30 one time at step S1, the phonetic conversation device 30 determines the number of times of touches/eye contact and a time interval, and transmits the number of times of touches/eye contact and the time interval to the mobile terminal 50 (S11).

The question and answer unit 52 of the mobile terminal 50 generates an answer according to the touch number of times and the time interval that are transmitted from the phonetic conversation device 30 (S12), and transmits data in which a voice is synthesized to an answer text in the mobile terminal 50 to the phonetic conversation device 30 (S13).

The phonetic conversation device 30 decodes and outputs voice synthesis data that is transmitted from the mobile terminal 50 (S14), and when outputting a voice from the phonetic conversation device 30, LED light is controlled and a facial expression image is output (S15).

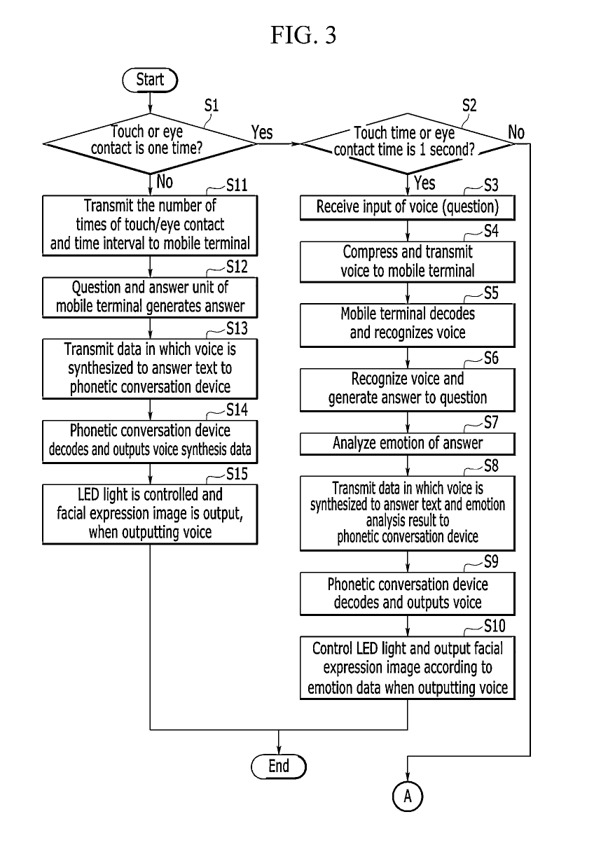

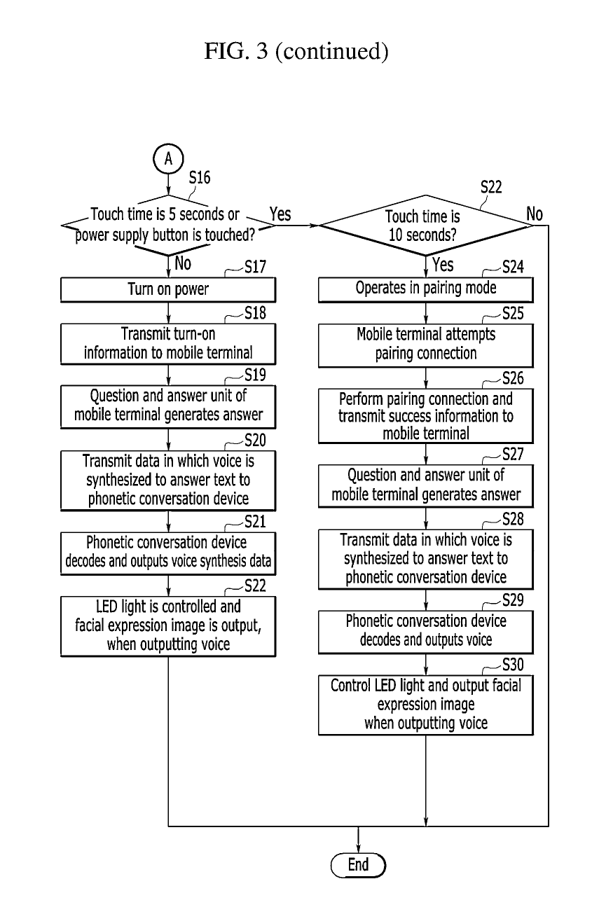

FIG. 3 is a message transmitting and receiving flowchart between a phonetic conversation device and a mobile terminal in a phonetic conversation system according to an exemplary embodiment of the present invention.

Referring to FIG. 3, the phonetic conversation device 30 determines whether the user 10 touches or makes eye contact with the image input unit 37 of the phonetic conversation device 30 one time (S1), and if the user 10 touches or makes eye contact with the image input unit 37 of the phonetic conversation device 30 one time, the phonetic conversation device 30 determines whether a touch time or an eye contact time is 1 second (S2).

If a touch time or an eye contact time is 1 second, the phonetic conversation device 30 receives an input of a voice (question) of the user 10 (S3) and compresses the voice and transmits the compressed voice to the mobile terminal 50 (S4).

The mobile terminal 50 decodes and recognizes the voice that is compressed in and transmitted from the phonetic conversation device 30 (S5), generates an answer to a question (S6), and analyzes an emotion of the answer (S7).

The mobile terminal 50 transmits voice synthesis data in which a voice is synthesized to an answer text and information about an emotion analysis result to the phonetic conversation device 30 (S8). For example, information about an emotion analysis result may be information about a light emitting condition such as a kind of light and a display cycle of light for displaying specific light in the light emitting unit 34 of the phonetic conversation device 30 and various facial expressions of an emotion that is extracted by the emotion determination unit 53, as shown in FIGS. 11 to 21.

The phonetic conversation device 30 decodes and outputs a voice that is transmitted from the mobile terminal 50 (S9), controls LED light according to emotion data, which is an emotion analysis result that is transmitted from the mobile terminal when outputting a voice, and outputs a facial expression image (S10).

If the user 10 does not touch or does not make eye contact with the image input unit 37 of the phonetic conversation device 30 one time at step S1, the phonetic conversation device 30 determines the number of times of touches/eye contact and a time interval, and transmits the number of times of touches/eye contact and the time interval to the mobile terminal 50 (S11).

The question and answer unit 52 of the mobile terminal 50 generates an answer according to the touch number of times and the time interval that are transmitted from the phonetic conversation device 30 (S12), and the mobile terminal 50 transmits data in which a voice is synthesized to an answer text to the phonetic conversation device 30 (S13).

The phonetic conversation device 30 decodes and outputs voice synthesis data that is transmitted from the mobile terminal 50 (S14), and when outputting a voice from the phonetic conversation device 30, LED light is controlled and a facial expression image is output (S15).

Thereafter, if a touch time or an eye contact time is not 1 second at step S2, the phonetic conversation device 30 determines whether a touch time is 5 seconds or a power supply button is touched (S16).

If a touch time is 5 seconds or if a power supply button is touched, the phonetic conversation device 30 turns on power (S17) and transmits turn-on information to the mobile terminal 50 (S18).

When the question and answer unit 52 of the mobile terminal 50 receives turn-on information of the phonetic conversation device 30, the question and answer unit 52 generates an answer (S19) and transmits data in which a voice is synthesized to the generated answer text to the phonetic conversation device 30 (S20).

The phonetic conversation device 30 decodes and outputs the voice synthesis data that is transmitted from the mobile terminal 50 (S21), and when outputting a voice from the phonetic conversation device 30, the LED light is controlled and a facial expression image is output (S22).

If a touch time is not 5 seconds or a power supply button is not touched at step S16, the phonetic conversation device 30 determines whether a touch time is 10 seconds (S23), and if a touch time is 10 seconds, the phonetic conversation device 30 is operated in a pairing mode (S24). Pairing may be connected by short range wireless communication such as Bluetooth and WIFI.

When the phonetic conversation device 30 is operated in a pairing mode, the mobile terminal 50 attempts a pairing connection (S25), and the phonetic conversation device 30 performs a pairing connection with the mobile terminal 50 and transmits pairing connection success information to the mobile terminal 50 (S26).

When the question and answer unit 52 of the mobile terminal 50 receives pairing connection success information from the phonetic conversation device 30, the question and answer unit 52 generates an answer (S27) and transmits data in which a voice is synthesized to a generated answer text to the phonetic conversation device 30 (S28).

The phonetic conversation device 30 decodes and outputs the voice synthesis data that is transmitted from the mobile terminal 50 (S29), and when outputting a voice from the phonetic conversation device 30, light is controlled and a facial expression image is output (S30).

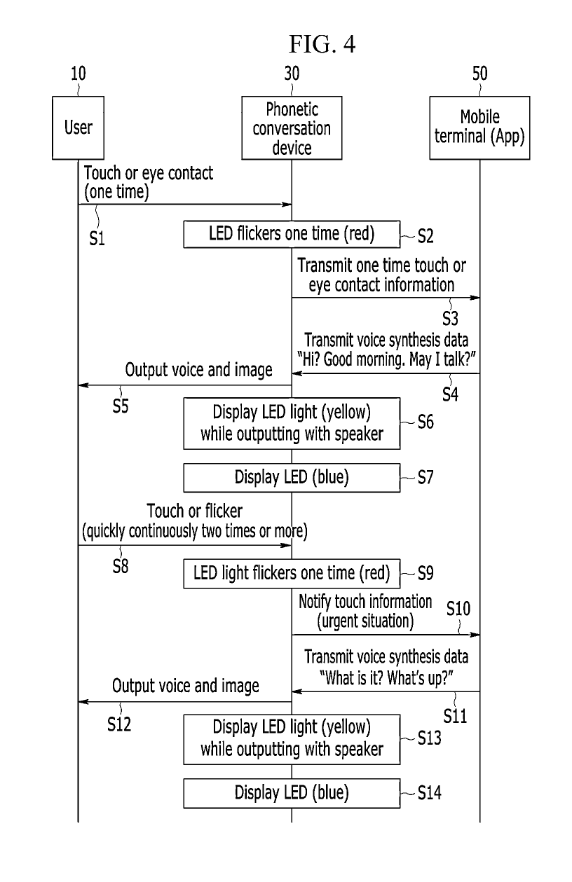

FIG. 4 is a diagram illustrating an example of transferring emotion information to an App by a touch.

Referring to FIG. 4, when the user 10 touches a button of a dip switch, a toggle switch, and a standby power touch method switch of the phonetic conversation device 30 and the touch recognition unit 33 one time or makes eye contact one time with the image input unit 37 of the phonetic conversation device 30 (S1), a light emitting diode (LED) of the phonetic conversation device 30 flickers a predetermined color one time, for example, red (S2).

The phonetic conversation device 30 transmits one time touch or eye contact information to the mobile terminal (App) 50 (S3), receives an answer conversation (S4), and outputs a voice and an image (S5). Here, answer conversation that the phonetic conversation device 30 receives from the mobile terminal 50 is voice synthesis data, and may be, for example, a content such as “Hi? Good morning. May I talk?”. While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S6), and when an output is terminated, the LED emits and displays again blue, which is a basic color (S7).

When the user 10 quickly continuously touches a button of a dip switch, a toggle switch, and a standby power touch method switch of the phonetic conversation device 30 and the touch recognition unit 33 two times or quickly continuously flickers an eye two times or more (S8), the LED of the phonetic conversation device 30 flickers a predetermined color one time, for example, red (S9).

The phonetic conversation device 30 notifies an urgent situation by transmitting quick continuous touches or eye flickering information to the mobile terminal (App) 50 two times or more (S10), receives answer conversation (S11), and outputs a voice and an image (S12). Here, answer conversation that the phonetic conversation device 30 receives from the mobile terminal 50 is voice synthesis data, and may be, for example, a content such as “What is it? What's up?”. While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S13), and when an output is terminated, the LED again emits and displays blue, which is a basic color (S14).

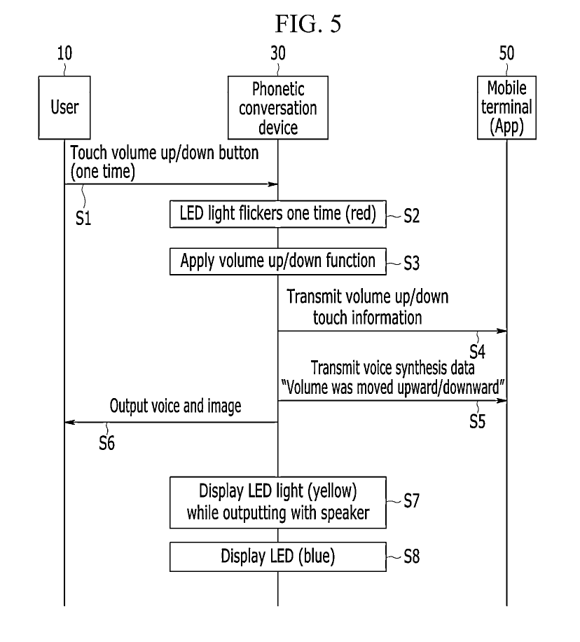

FIG. 5 is a diagram illustrating an example of a volume control of a phonetic conversation device according to an exemplary embodiment of the present invention.

Referring to FIG. 5, when the user 10 presses a volume up/down button of the phonetic conversation device 30 one time (S1), the LED of the phonetic conversation device 30 flickers one time with a predetermined color, for example, red (S2), and a volume up/down function is applied (S3).

The phonetic conversation device 30 transmits volume up/down touch information to the mobile terminal (App) 50 (S4), receives answer conversation (S5), and outputs a voice and an image (S6). Here, answer conversation that the phonetic conversation device 30 receives from the mobile terminal 50 is voice synthesis data and may be, for example, a content such as “A volume was turned up/down”. While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S7), and when an output is terminated, the LED again emits and displays blue, which is a basic color (S8).

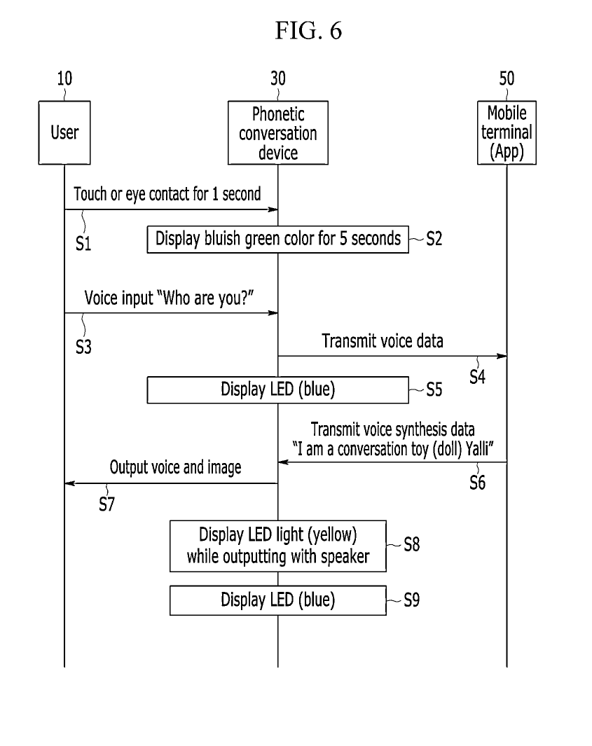

FIG. 6 is a diagram illustrating an example of a conversation with a conversation toy (doll) by a user voice input.

Referring to FIG. 6, when the user 10 touches a central touch portion of the phonetic conversation device 30 for 1 second or makes eye contact with the image input unit 37 for 1 second (S1), the LED of the phonetic conversation device 30 displays a predetermined color, for example, a bluish green color, for 5 seconds (S2), and the phonetic conversation device 30 enters a voice input standby state (for 5 seconds).

The phonetic conversation device 30 receives a voice input of the user 10 (S3). In this case, the user inputs a voice to a microphone of the phonetic conversation device 30. The input voice may be, for example, a content such as “Who are you?”.

Even if a touch is not operated, the phonetic conversation device 30 may determine whether the input voice is a person's voice using a self voice detection engine. The voice detection engine may use various voice detection algorithms.

The phonetic conversation device 30 transmits input voice data of the user 10 to the mobile terminal (App) 50 (S4), and the LED of the phonetic conversation device 30 again emits and displays blue, which is a basic color (S5).

The phonetic conversation device 30 receives answer conversation and a facial expression image that is related thereto from the mobile terminal (App) 50 (S6), and outputs the answer conversation and the facial expression image to the voice output unit 32 and the image output unit 36 (S7). Here, answer conversation that the phonetic conversation device 30 receives from the mobile terminal 50 is voice synthesis data, and may be, for example, a content such as “I am a conversation toy (doll) Yalli.”. While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S8), and when an output is terminated, the LED again emits and displays blue, which is a basic color (S9).

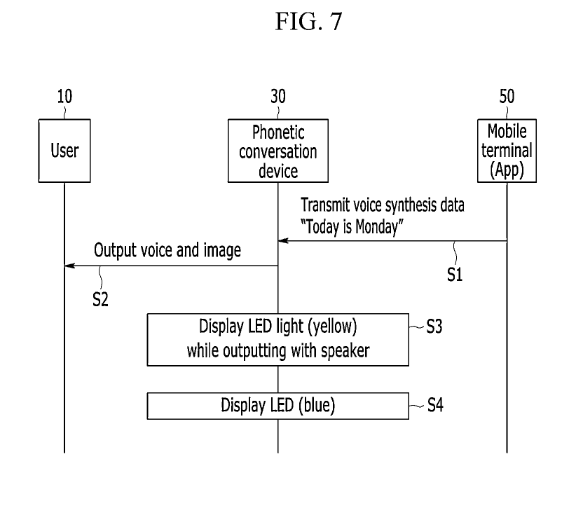

FIG. 7 is a diagram illustrating an example of generating phonetic conversation and having conversation in a mobile terminal App.

Referring to FIG. 7, even if a voice is not transmitted through the phonetic conversation device 30, the mobile terminal (App) 50 generates answer conversation, converts the answer conversation to voice synthesis (TTS) data, and transmits the TTS data in a sound form to the phonetic conversation device 30 (S1).

The phonetic conversation device 30 receives answer conversation and a facial expression image that is related thereto that are transmitted from the mobile terminal (App) 50, and outputs the answer conversation and the facial expression image to the voice output unit 32 and the image output unit 36 (S2). Here, answer conversation that the phonetic conversation device 30 receives from the mobile terminal 50 is voice synthesis data, and may be, for example, a content such as “Today is Monday.”. While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S3), and when an output is terminated, the LED again emits and displays a blue color, which is a basic color (S4).

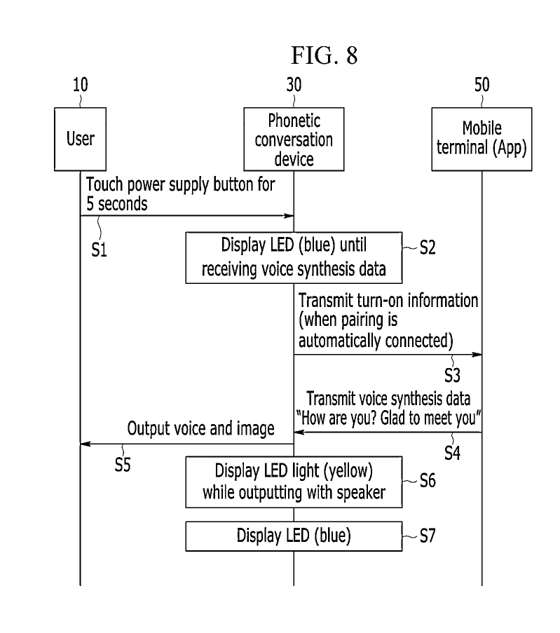

FIG. 8 is a diagram illustrating an example of turning on a phonetic conversation device according to an exemplary embodiment of the present invention.

Referring to FIG. 8, when the user 10 touches a power supply button of the phonetic conversation device 30 and the touch recognition unit 33 for 5 seconds (S1), until the LED of the phonetic conversation device 30 receives voice synthesis data from the mobile terminal (App) 50, the LED emits and displays blue, which is a basic color (S2).

When the phonetic conversation device 30 is automatically connected by pairing with the mobile terminal (App) 50, the phonetic conversation device 30 transmits turn-on information to the mobile terminal (App) 50 (S3), and the phonetic conversation device 30 receives answer conversation (answer data) or a facial expression image that is related thereto from the mobile terminal (App) 50 (S4), and outputs the answer conversation (answer data) or the facial expression image to the voice output unit 32 and the image output unit 36 (S5). Here, the mobile terminal (App) 50 converts answer data to a voice by a TTS function, compresses the voice data, transmits the voice data by wireless to the phonetic conversation device 30, and thus the phonetic conversation device 30 decodes the compressed voice data that is transmitted from the mobile terminal (App) 50, outputs the decoded voice data to the voice output unit 32, decodes the compressed facial expression image, and outputs the decoded facial expression image to the image output unit 36. Answer conversation that the phonetic conversation device 30 receives from the mobile terminal (App) 50 is TTS data, and may be, for example, a content such as “How are you? Glad to meet you.”. While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S6), and when an output is terminated, the LED again emits and displays blue, which is a basic color (S7).

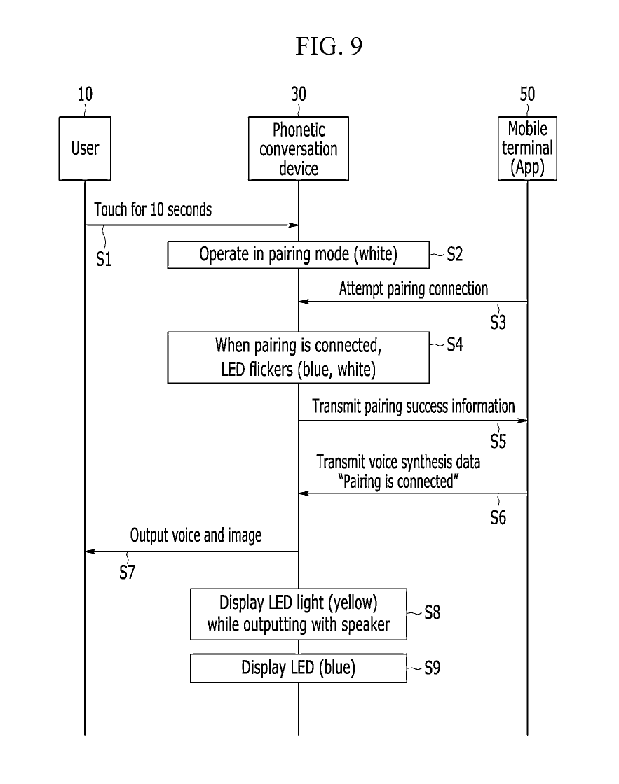

FIG. 9 is a diagram illustrating an example of a pairing function according to an exemplary embodiment of the present invention.

Referring to FIG. 9, when the user 10 touches the phonetic conversation device 30 for 10 seconds (S1), the phonetic conversation device 30 is operated in a pairing mode and enables the LED to emit and display white (S2).

The mobile terminal (App) 50 attempts a pairing connection to the phonetic conversation device 30 (S3), and when a pairing connection between the phonetic conversation device 30 and the mobile terminal (App) 50 is performed, the LED flickers with blue and white (S4). Thereafter, pairing success information is transmitted to the mobile terminal (App) 50 (S5).

The mobile terminal (App) 50 transmits voice synthesis data to the phonetic conversation device 30 (S6), and the phonetic conversation device 30 receives voice synthesis data and a facial expression image that is related thereto from the mobile terminal (App) 50 and outputs the voice synthesis data and the facial expression image to the voice output unit 32 and the image output unit 36 (S7). Here, answer conversation that the phonetic conversation device 30 receives from the mobile terminal (App) 50 is voice synthesis data, and may be, for example, a content such as “Pairing is connected.”. While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S8), and when an output is terminated, the LED again emits and displays blue, which is a basic color (S9).

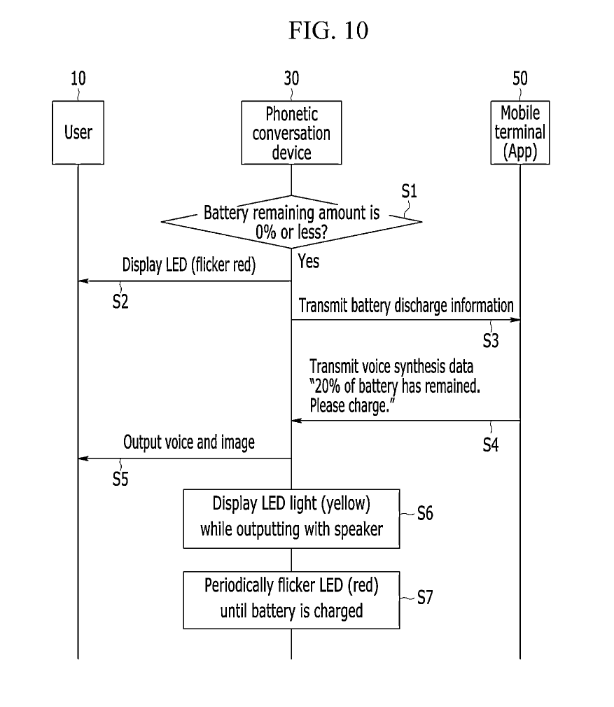

FIG. 10 is a diagram illustrating an example of a battery discharge warning of a phonetic conversation device according to an exemplary embodiment of the present invention.

Referring to FIG. 10, the phonetic conversation device 30 determines whether a battery remaining amount is 20% or less, and if the battery remaining amount is 20% or less, the LED displays a battery discharge warning while flickering with a red color (S2).

Thereafter, the phonetic conversation device 30 transmits battery discharge information to the mobile terminal (App) 50 (S3).

The mobile terminal (App) 50 transmits voice synthesis data to the phonetic conversation device 30 (S4), and the phonetic conversation device 30 receives voice synthesis data and a facial expression image that is related thereto from the mobile terminal (App) 50 and outputs the voice synthesis data and the facial expression image to the voice output unit 32 and the image output unit 36 (S5). Here, answer conversation that the phonetic conversation device 30 receives from the mobile terminal (App) 50 is voice synthesis data, and may be, for example, a content of “20% of the battery remains. Please charge.”

While such answer conversation and a facial expression image that is related thereto are output to the voice output unit 32 and the image output unit 36 of the phonetic conversation device 30, the LED of the phonetic conversation device 30 emits and displays a predetermined color, for example, yellow (S6), and until a battery is charged, the LED periodically repeatedly flickers with a red color (S7).

According to an embodiment of the present invention, as a user has a conversation by wired communication or wireless communication with a toy (doll) to which a phonetic conversation device is attached, an answer to the user's question can be quickly and clearly transferred.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A phonetic conversation method using wired and wireless communication networks, the phonetic conversation method comprising:
receiving, by a voice input unit of a phonetic conversation device, a voice that is input by a user in a case of a touch, an eye contact, or a user voice input;
receiving, by a wired and wireless communication unit of the phonetic conversation device, a voice that is input through the voice input unit and transmitting the voice to a mobile terminal;
receiving, by the wired and wireless communication unit, an answer voice that is transmitted from the mobile terminal; and
receiving and outputting, by a voice output unit of the phonetic conversation device, a voice from the wired and wireless communication unit.

2. The phonetic conversation method of claim 1, wherein the receiving of a voice that is input by a user comprises:
recognizing, by a touch recognition unit or an image output unit of the phonetic conversation device, a user touch;
receiving, by the voice input unit of the phonetic conversation device, a voice that is input by the user, after a user touch is recognized in the touch recognition unit or the image output unit or while a user touch is maintained; and
receiving, by the voice input unit of the phonetic conversation device, a voice that is input by the user, after a voice is input without a user touch to the touch recognition unit or the image output unit, when the voice is determined to a user voice.

3. The phonetic conversation method of claim 1, wherein the receiving of a voice that is input by a user comprises:
recognizing, by an image input unit of the phonetic conversation device, an eye contact of a user;
receiving, by the voice input unit of the phonetic conversation device, a voice that is input by the user, after the eye contact of the user is recognized through the image output unit or while the eye contact of the user is maintained; and
receiving, by the voice input unit of the phonetic conversation device, a voice that is input by the user, after a voice is input without the eye contact of the user through the image output unit, when the voice is determined to a user voice.

4. The phonetic conversation method of claim 1, wherein the receiving and outputting of a voice comprises emitting and displaying, by a light emitting unit of the phonetic conversation device, light with a specific color based on an emotion that is determined for the voice while receiving and outputting a voice from the wired and wireless communication unit.

5. The phonetic conversation method of claim 4, wherein a light emitting color and a display cycle of the light emitting unit are determined based on an emotion that is determined for the voice in the mobile terminal.

6. The phonetic conversation method of claim 5, wherein the emotion is recognized from a natural language text after converting the voice to a text.

7. The phonetic conversation method of claim 1, wherein the receiving and outputting of a voice comprises outputting, by a light emitting unit of the phonetic conversation device, a facial expression image based on an emotion that is determined for the voice while receiving and outputting a voice from the wired and wireless communication unit.

8. The phonetic conversation method of claim 1, wherein the receiving and outputting of a voice comprises outputting, by a light emitting unit of the phonetic conversation device, an emoticon based on an emotion that is determined for the voice while receiving and outputting a voice from the wired and wireless communication unit.

9. A phonetic conversation device using wired and wireless communication networks, the phonetic conversation device comprising:
a voice input unit configured to receive a voice that is input by a user in a case of a touch, an eye contact, or a user voice input;
a wired and wireless communication unit configured to receive a voice that is input through the voice input unit, to transmit the voice to a mobile terminal, and to receive the voice that is transmitted from the mobile terminal; and
a voice output unit configured to receive the voice from the wired and wireless communication unit and to output the voice.

10. The phonetic conversation device of claim 9, further comprising a touch recognition unit configured to recognize a user touch,
wherein after a user touch is recognized in the touch recognition unit or while a user touch is maintained, a voice is input by the user.

11. The phonetic conversation device of claim 9, further comprising an image input unit configured to receive an input of a user image,
wherein after the eye contact of the user is recognized in the image input unit or while the eye contact is maintained, a voice is input by the user.

12. The phonetic conversation device of claim 9, further comprising a light emitting unit configured to emit and displays light with a specific color based on an emotion that is determined for the voice while the voice output unit receives a voice from the wired and wireless communication unit and outputs the voice.

13. The phonetic conversation device of claim 12, wherein a light emitting color and a display cycle of the light emitting unit are determined based on an emotion that is determined for the voice in the mobile terminal.

14. The phonetic conversation device of claim 13, wherein the emotion is recognized from a natural language text after converting the voice to a text.

15. The phonetic conversation device of claim 9, further comprising an image output unit configured to output an image,
wherein while the voice output unit receives a voice from the wired and wireless communication unit and outputs the voice, the image output unit outputs a facial expression image based on an emotion that is determined for the voice.

16. The phonetic conversation device of claim 9, further comprising an image output unit configured to output an image,
wherein while the voice output unit receives a voice from the wired and wireless communication unit and outputs the voice, the image output unit outputs an emoticon based on an emotion that is determined for the voice.
